(19) United States
(12) Patent Application Publication
(10) Pub. No.: US 2014/0107409 A1
(43) Pub. Date: Apr. 17, 2014

(54) Portable Vibrating Bidet

(71) Applicants: Alicia E BAILEY, Stockton, CA (US); Gary Dewayne BAILEY, Stockton, CA (US)

(72) Inventors: Alicia E BAILEY, Stockton, CA (US); Gary Dewayne BAILEY, Stockton, CA (US)

(21) Appl. No.: 13/685,920

(22) Filed: Nov. 27, 2012

Related U.S. Application Data
(60) Provisional application No. 61/713,888, filed on Oct. 15, 2012.

(51) Int. Cl. E03D 9/08; A61H 19/00

(52) U.S. Cl. CPC E03D 9/08; A61H 19/44
USPC 600/38; 4/443

(57) ABSTRACT

A portable vibrating bidet is a portable, cylindrical device with a telescoping hose that allows the user to deliver cleansing liquid and air to clean themselves after using the restroom. Cleansing liquid is drawn from a liquid reservoir by a pump to a spray nozzle of the telescoping hose, and air is drawn from a plurality of air vents to the spray nozzle by a fan. The telescoping hose extends from and retracts into a hose cavity in the cylindrical body and is covered when not in use by a cap that uses an ultra-violet light source to sterilize the telescoping hose after use. A heater controls the temperature of the dispensed fluid. A vibrator delivers vibrations through the cylindrical body and cap for added functionality as a pleasure device. A plurality of exterior controls allows the user to control the various functions of the portable vibrating bidet.

The current application claims a priority to the U.S. Provisional Patent application Ser. No. 61/713,888 filed on Oct. 15, 2012.

### FIELD OF THE PRESENT INVENTION

The present invention relates generally to personal hygiene. More particularly, the present invention relates to a portable self-cleansing device that includes a vibrating function for personal pleasure.

### BACKGROUND OF THE PRESENT INVENTION

Hygiene refers to the set of practices perceived by a community to be associated with the preservation of health and healthy living. In medicine and in domestic and everyday life settings, hygiene practices are employed as preventative measures to reduce the incidence and spreading of disease. While in modern medical sciences there is a set of standards of hygiene recommended for different situations, what is considered hygienic or not can vary between different cultures, genders and other groups. Some regular hygienic practices may be considered good habits by a society while the neglect of hygiene can be considered disgusting, disrespectful or even threatening. In general, hygiene mostly means practices that prevent the spread of disease-causing organisms. Preventing the spread of infectious diseases means breaking the chain of infection transmission, which is the principle that is the chain of infection is broken, infection cannot spread.

Toilet paper is a soft tissue paper product primarily used to maintain personal hygiene after human defecation, urination or other bodily functions, and is the generally the primary method in many Western countries of cleaning one's self after using the restroom. Another method of post-restroom usage cleaning is to use water. A bidet is a device invented in France the late 17^{th} century that is generally known as a low-mounted plumbing fixture or type of sink intended for washing the genitalia, inner buttocks and anus. The bidet is commonplace in many European countries, especially in Spain, Portugal, Italy and Greece, as well as Japan and areas in the Middle East. Depending on cleansing techniques that vary from person to person, washing with water is generally more effective at removing unwanted contaminating particles from one's skin than rubbing with paper or cloth due to the fluid nature of water, whereby molecules of water more thoroughly contact, take hold of and remove unwanted particles than rubbing the area with tissue paper.

According to Scientific American, Americans use 36.5 billion rolls of toilet paper per year, representing the pulping of approximately 15 million trees. Using bidets contributes to reducing paper waste, but also provide a more effective and comfortable way of self-cleansing. Toilet paper is more abrasive than water, in addition to being bleached to make it white, and is often perfumed, possibly causing additional irritation. In addition, using a bidet may be performed hands-free, reducing the chance of the user getting germs on their hands and spreading bacteria. Bidets are slowly but increasingly gaining acceptance in North America, but in many places it is still uncommon to find anything but toilet paper in public restrooms. Other situations may arise in which toilet paper is not available, such as when camping or hiking. Portable bidet devices have been designed, however they offer no means of drying one's self after washing and no control of the temperature of the liquid being dispensed, and the existing portable bidets are not easily concealed when in storage.

It is therefore an object of the present invention to provide a portable bidet that may be easily concealed and carried with an integrated dryer that allows the present invention to be used in any situation as no toilet paper is needed for cleaning or drying one's self. The present invention also includes a heater so that the temperature of the cleansing solution and/or may be controlled, as well as a vibrator so that the present invention may be additionally utilized as a pleasure device.

### BRIEF DESCRIPTION OF THE DRAWINGS

FIG. 1 is a front view of the present invention with the cap engaged with the cylindrical body and the plurality of external controls.

FIG. 2 is a perspective view of the present invention with the cap removed and the telescoping hose retracted into the hose cavity.

FIG. 3 is a perspective view of the present invention with the cap removed and the telescoping hose extended.

FIG. 4 is a perspective view of the present invention with the cap removed and the telescoping hose extended with one of the plurality of flexible sections bent.

FIG. 5 is a perspective section view of the cylindrical body and the cap engaged with each other with no internal components.

FIG. 6 is a perspective view of a half section of the cylindrical body showing the internal components.

FIG. 7 is a rear perspective view of a half section of the cylindrical body showing the female power connection and the reservoir access port.

FIG. 8 is a perspective section view of the cap with the male power connection and the UV light source.

FIG. 9 is a cutaway view of the heater showing the heating passage and the plurality of heating coils according to the preferred embodiment of the present invention.

FIG. 10 is a cutaway view of the intersection between the exit port, the air passage and the liquid passage of the junction tubing showing the passage control valve according to the preferred embodiment of the present invention.

FIG. 11 is a schematic diagram describing the electrical connections between the microprocessor, the power source and the electronic components of the preferred embodiment present invention.

FIG. 12 is a schematic diagram describing the electrical connections between the microprocessor, the power source and the electronic components of an alternate embodiment of the present invention.

### DETAIL DESCRIPTIONS OF THE PRESENT INVENTION

All illustrations of the drawings are for the purpose of describing selected versions of the present invention and are not intended to limit the scope of the present invention.

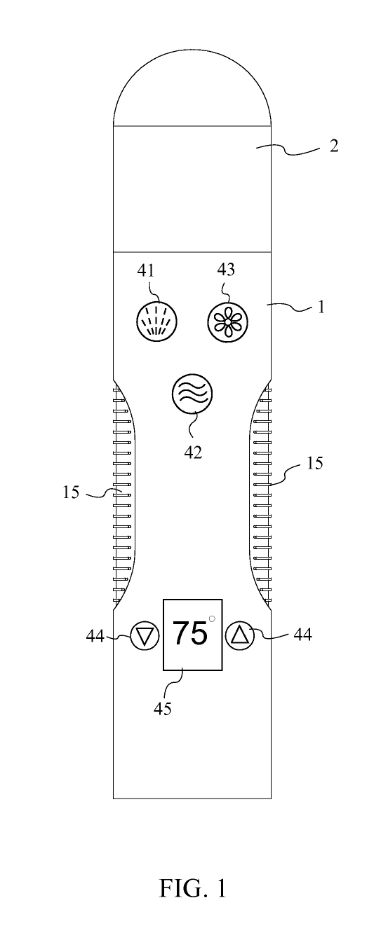

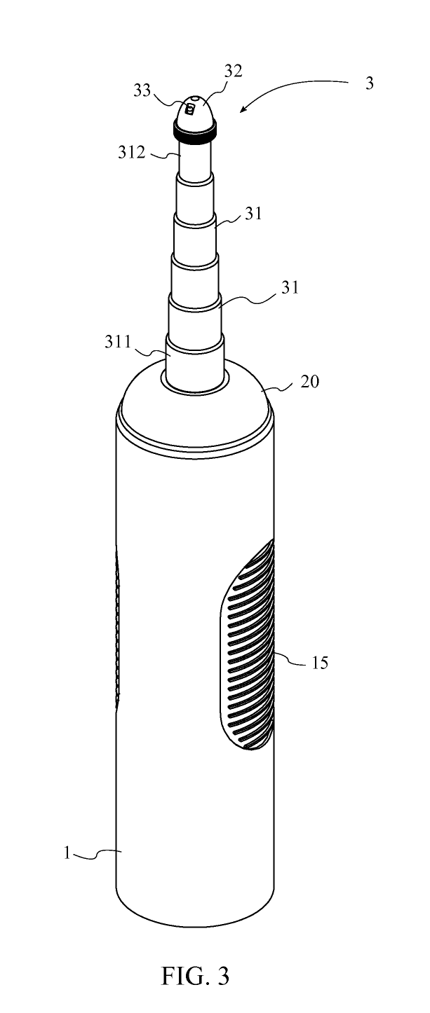

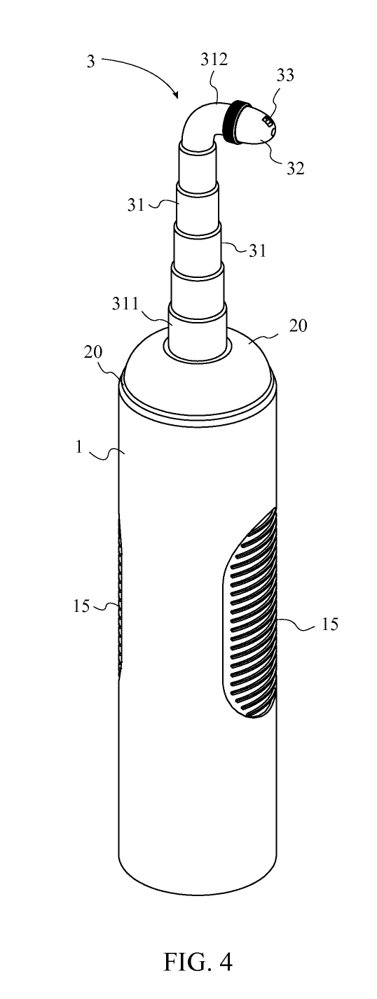

The present invention is a portable vibrating bidet with an extendable hose that delivers cleansing solution and air with a number of feature controls. Referring to FIGS. 1-6, the present invention generally comprises a cylindrical body 1, a cap 2, a telescoping hose 3, a plurality of exterior controls 4, a junction tubing 5, a fan 6, a partition 7, a motor 8, a pump 9, a liquid reservoir 10, a heater 11, a vibrator 12, a power source 13, a microprocessor 14, and a gripping pad 15.

The present invention can be used as a self-cleansing device or as a pleasure device. When the cap 2 is removed from the portable vibrating bidet, the spray nozzle 32 and telescoping hose 3 can be extended from the cylindrical body 1. The portable vibrating bidet can then be used as a self-cleansing device for one's vagina or anus using the plurality of exterior controls 4. When the cap 2 is connected to the body, the portable vibrating bidet can be used as a pleasure device in conjunction with the vibrating feature.

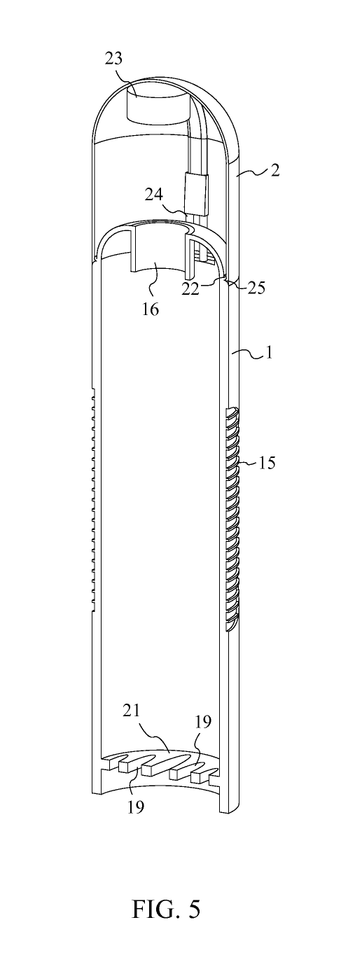

Referring to FIG. 5, the cylindrical body 1 is the main body of the present invention that contains or supports the majority of the components of the present invention. The cylindrical body 1 is an elongated, hollow shell, with one flat extremity 21 and one rounded extremity 20. The rounded extremity 20 interfaces with the cap 2. In the preferred embodiment of the present invention, the cylindrical body 1 comprises a body protrusion 22 concentrically positioned adjacent to the rounded extremity 20, facilitating a snap interface with the cap 2. In another embodiment of the present invention, the interface between the cylindrical body 1 and the cap 2 is a threaded screwing interface, or another previously known method for allowing the cap 2 to be removably engaged with the cylindrical body 1.

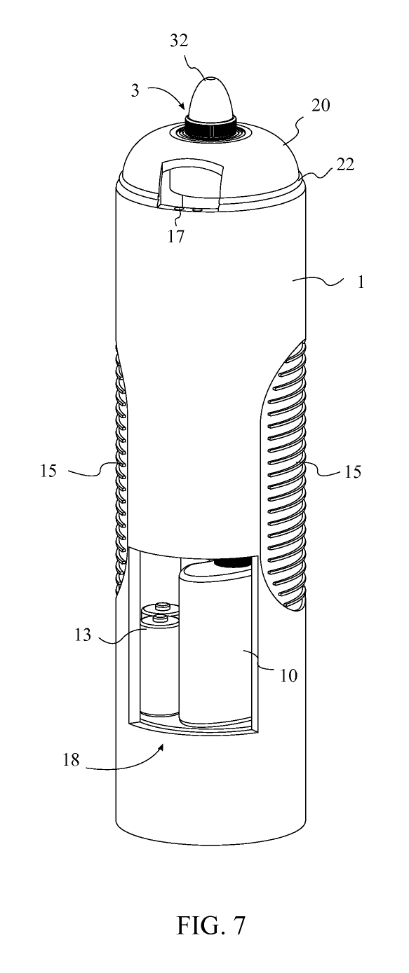

The cylindrical body 1 further comprises a hose cavity 16, a female power connection 17, a reservoir access port 18, and a plurality of air vents 19. The hose cavity 16 is concentrically positioned within the rounded extremity 20 of the cylindrical body 1. The female power connection 17 is any type of electrical connection that facilitates a removably engaging electrical connection between the cap 2 and the cylindrical body 1. As can be seen in FIG. 7, the female power connection 17 is positioned on the rounded extremity 20 of the cylindrical body 1 adjacent to the hose cavity 16. The plurality of air vents 19 is a number of slots or other shapes cut in the flat extremity 21 of the cylindrical body 1, positioned opposite the hose cavity 16 along the cylindrical body 1. Referring to FIG. 7, the reservoir access port 18 is an opening in the cylindrical body 1 with a removable cover between the rounded extremity 20 and the flat extremity 21 adjacent to the liquid reservoir 10 that can be opened in order to refill or replace the liquid reservoir 10.

Referring to FIGS. 1-4, the gripping pad 15 is a plurality of areas positioned around the cylindrical body 1 between the hose cavity 16 and the plurality of air vents 19 that allows a user to maintain a secure grip on the cylindrical body 1. In the preferred embodiment of the present invention, the gripping pad 15 is made of rubber or another suitable material with a high coefficient of friction with human skin. The gripping pad 15 preferably comprises features such as, but not limited to, a pattern of protrusions such as ridges or bumps and an indent or plurality of indents in order to facilitate a secure grip.

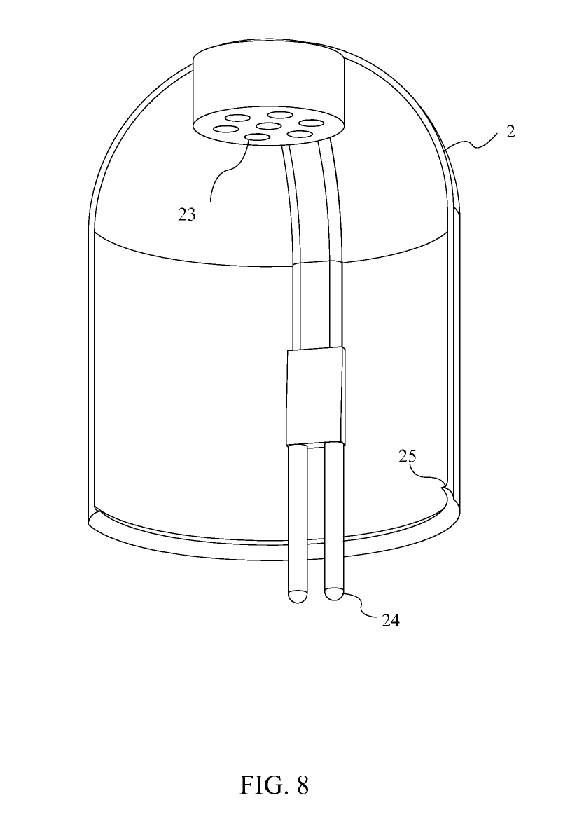

Referring to FIG. 8, the cap 2 is a cylindrical shell with a dome at one extremity and an opening at the other extremity that is concentrically positioned with and removably engaged to the cylindrical body 1 adjacent to the hose cavity 16. In the preferred embodiment of the present invention, the cap 2 comprises a cap 2 protrusion 25 that snaps over the body protrusion 22 in order to engage the cap 2 with the cylindrical body 1. In alternate embodiments of the present invention, the cap 2 may comprise a threaded screw interface or another previously known method for allowing the cap 2 to be removably engaged with the cylindrical body 1. The cap 2 further comprises an ultra-violet (UV) light source 23 and a male power connection 24.

The UV light source 23 utilizes well-known technology to produce UV light when the cap 2 is engaged with the cylindrical body 1 for a certain length of time in order to sterilize the telescoping hose 3 after the telescoping hose 3 is retracted into the hose cavity 16 and the cap 2 is engaged with the cylindrical body 1. In another embodiment of the present invention, the UV light is manually turned on and off by the user. In another embodiment of the present invention, another suitable means of sterilization is used. The UV light source 23 is concentrically positioned within the cap 2 opposite the male power connection 24, and the UV light source 23 is electrically connected to the male power connection 24. The male power connection 24 is any type of electrical connection that facilitates a removably engaging electrical connection between the cap 2 and the female power connection 17. The male power connection 24 is removably connected to the female power connection 17 when the cap 2 is engaged with the cylindrical body 1, wherein the female power connection 17 allows electrical current to flow to the male power connection 24 when the male power connection 24 and the female power connection 17 are connected to each other.

In the preferred embodiment of the present invention, the cap 2 further comprises a signaling device to indicate whether the UV light source 23 is on or not. In one embodiment of the present invention, the signaling device is a light source such as, but not limited to, a light emitting diode or an incandescent bulb. In another embodiment of the present invention, the signaling device is the cap 2 itself, which is made of or comprises a section of clear or translucent material so that the user may visually ascertain the state of the UV light source 23.

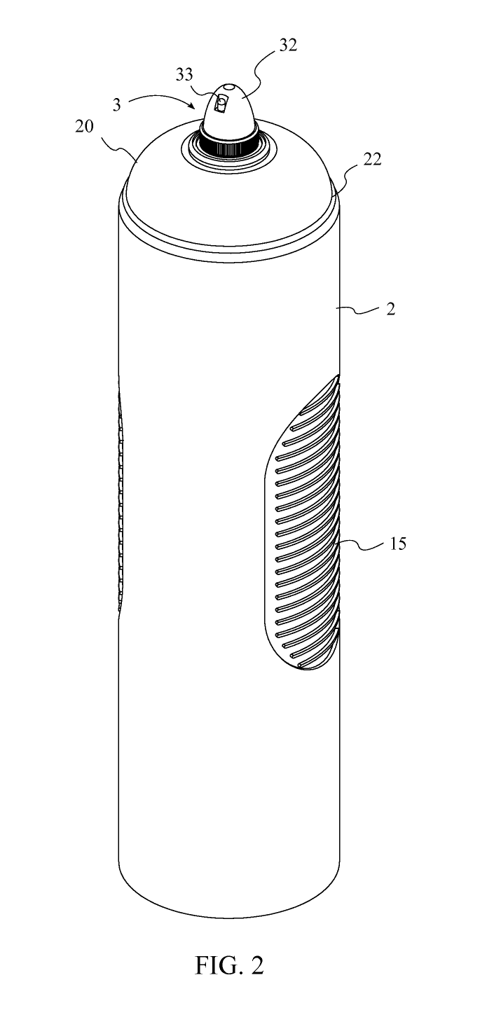

Referring to FIGS. 2-5, the telescoping hose 3 is a conduit connected at the rounded extremity 20 of the cylindrical body 1 through which fluid, either liquid from the liquid reservoir 10 or air from the fan 6, is delivered. The telescoping hose 3 comprises a plurality of flexible sections 31, a spray nozzle 32, and a nozzle light source 33. Each of the plurality of flexible sections 31 is concentrically attached to and positioned within each other, in addition to being telescopically engaged with each other, so that the telescoping hose 3 may be extended from and retracted into the hose cavity 16. In the preferred embodiment of the present invention, some or each of the plurality of flexible sections 31 is made of a material that allows the flexible section to be bent to a desired angle. The telescoping action of the telescoping hose 3 may be controlled by a hose extension mechanism, or the telescoping hose 3 may be extended and retracted by hand. In alternate embodiments of the present invention, the telescoping hose 3 may be designed in any other way that facilitates a storage position for the telescoping hose 3, such as, but not limited to, being made of one piece that extends and retracts or folds into the side of the device.

The plurality of flexible sections 31 comprises a first section 311 and a last section 312 that are positioned opposite each other such that the first section 311 and the last section 312 are opposite extremities of the telescoping hose 3. One or more of the plurality of flexible sections 31 may be connected between the first section 311 and the last section 312. The first section 311 is connected within the hose cavity 16.

The spray nozzle 32 utilizes previously known technology or apparatuses to deliver fluid with desired fluid characteristics, such as, but not limited to, direction, exit velocity, mass flow rate, and area of coverage. In the preferred embodiment of the present invention, the spray nozzle 32 is rotatably attached to the last section 312, so that the spray nozzle 32 may be rotated in order to control direction and other flow characteristics of any fluid dispensed through the spray nozzle 32 in a manner similar to common twist nozzles. Twisting the spray nozzle 32 in one direction results in a single stream fluid deliver, while twisting the spray nozzle 32 the opposite direction results in a spread out spray fluid delivery. Alternate embodiments of the present invention may comprise different types of nozzles appropriate to the spirit of the present invention, such as, but not limited to, a hydro jet, a laminar jet, an atomizer nozzle, or a swirl nozzle. In one embodiment of the present invention, the spray nozzle 32 also comprises a nozzle vibrator 12.

The nozzle light source 33 is any light source appropriate to the spirit of the present invention that allows the user to illuminate the area to be cleansed during the cleansing activity, such as, but not limited to, a light emitting diode, an electron stimulated luminescence lamp, or an incandescent light bulb. The nozzle light source 33 is positioned on the spray nozzle 32 and oriented parallel to the spray nozzle 32 and the direction of fluid dispensing.

Referring to FIG. 1, the plurality of exterior controls 4 comprises any appropriate electrical or mechanical switches, buttons, digital touch screens, displays or other controls in order to facilitate control of the various functions of the present invention. Each of the plurality of exterior controls 4 is positioned on the outer surface of the cylindrical body 1 between the hose cavity 16 and the plurality of air vents 19. In the preferred embodiment of the present invention, the plurality of exterior controls 4 comprises a spray function control 41, a dryer function control 42, a vibrating function control 43, a temperature control 44, and a display screen 45. In the preferred embodiment of the present invention, the spray function control 41, the dryer function control 42, and the vibrating function control 43 are each a single button that linearly cycles through various tiers or modes of each function.

For example, pressing the vibrating function control 43 once put the vibrator 12 to a low setting. Pressing the vibrating function control 43 again put the vibrator 12 to a medium setting, pressing the vibrating function control 43 a third time puts the vibrator 12 on a high setting, and pressing the vibrating function control 43 a fourth time turns the vibrator 12 off. In one embodiment of the present invention, a predetermined amount of cleansing fluid is dispensed through the spray nozzle 32 upon pressing the spray function control 41 a single time. In another embodiment of the present invention, cleansing fluid is dispensed through the spray nozzle 32 for as long as the spray function control 41 is held pressed. In the preferred embodiment of the present invention, the temperature function control comprises a temperature increase button and a temperature decrease button, which serve to respectively increase and decrease the temperature of the cleansing fluid or air being dispensed from the spray nozzle 32. The display screen 45 displays information such as, but not limited to, the currently selected temperature of the heater 11 or of the dispensed fluid or the speed or mode of vibration or fluid dispensing. In another embodiment of the present invention, one of the plurality of exterior control 4 is used to automatically extend and retract the telescoping hose 3.

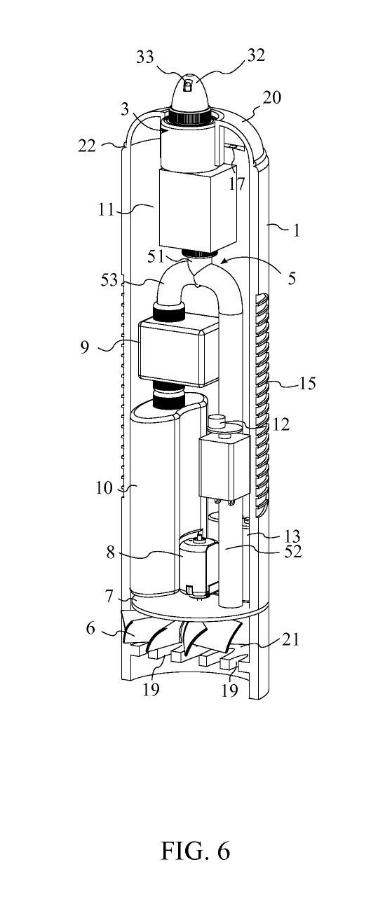

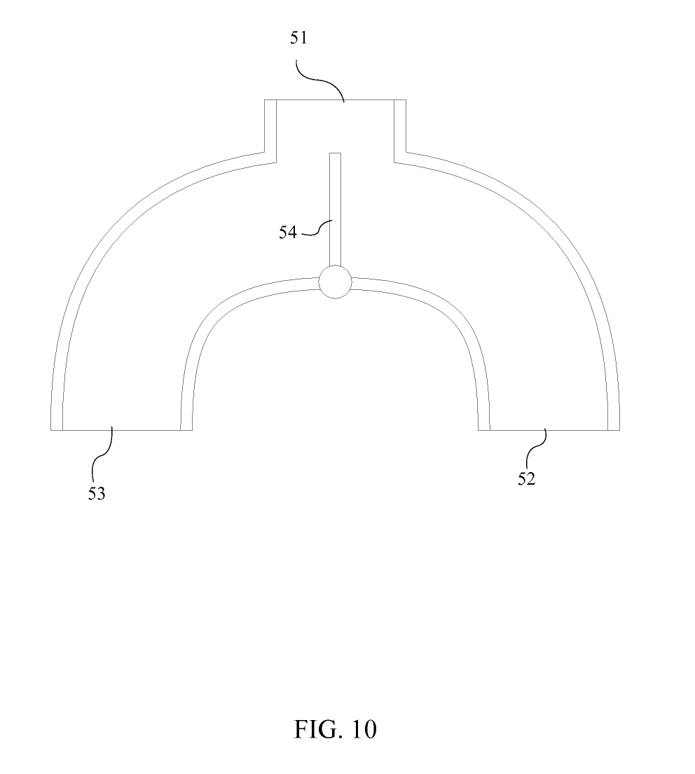

Referring to FIGS. 6, 10 and 11, the junction tubing 5 is a plurality of tubing passages positioned within the cylindrical body 1 that facilitate delivery of air, cleansing liquid or another fluid to the spray nozzle 32. The junction tubing 5 comprises an exit port 51, an air passage 52, a liquid passage 53, and a passage control valve 54. The exit port 51, the air passage 52, and the liquid passage 53 intersect each other at the passage control valve 54. The fan 6 draws air from the plurality of air vents 19 through the air passage 52 to the exit port 51. The liquid passage 53 is fluidally coupled to the pump 9 opposite the liquid reservoir 10 so that the pump 9 draws cleansing liquid from the liquid reservoir 10 through the liquid passage 53 to the exit port 51.

The exit port 51 is fluidally coupled to the air passage 52 and to the liquid passage 53 through the passage control valve 54. The passage control valve 54 is positioned between the air passage 52, the liquid passage 53, and the exit port 51, so that the liquid passage 53 and the air passage 52 are separated from each other by the passage control valve 54. The passage control valve 54 utilizes well-known valve techniques to allow only one of either air or cleansing liquid to be drawn through the exit port 51 at one time by closing the other passage. The passage control valve 54 may be controlled by the microprocessor 14 or operated manually. The exit port 51 is fluidally coupled to the telescoping hose 3 so that fluid drawn through the liquid passage 53 or the air passage 52 through the exit port 51 moves through the telescoping hose 3 to the spray nozzle 32.

Referring to FIG. 6, the fan 6 is a well-known device that comprises a plurality of angled blades that is positioned concentrically with an axle in order to force air in a certain direction. The fan 6 is positioned concentrically within the cylindrical body 1 adjacently to the plurality of air vents 19.

The partition 7 is a flat, circular disk concentrically positioned within the cylindrical body 1 adjacent to the fan 6 opposite the plurality of air vents 19. The partition 7 is perimetrically sealed to the cylindrical body 1 and the air passage 52 opposite the exit port 51 traverses through the partition 7, so that any air drawn by the fan 6 through the plurality of air vents 19 is directed through the air passage 52 to the exit port 51.

The motor 8 is any previously known device that converts electrical energy into rotary motion in order to drive the fan 6. The motor 8 is positioned within the cylindrical body 1 adjacent to the partition 7 opposite the fan 6 and is operatively coupled with the fan 6 through the partition 7.

The pump 9 is any well-known or new device that mechanically draws liquid from the liquid reservoir 10 and into the liquid passage 53. The pump 9 is positioned within the cylindrical body 1.

The liquid reservoir 10 is a chamber positioned within the cylindrical body 1 that contains liquid to be dispensed through the spray nozzle 32. The liquid reservoir 10 may contain water, a chemical solution or any other suitable liquid. The liquid reservoir 10 may be a removable cartridge that is replaced or refilled when the cartridge is empty, or the liquid reservoir 10 may be a permanent reservoir built into the cylindrical body 1 that is accessible by a hatch through the cylindrical body 1 in order to be refilled. The liquid reservoir 10 may be made of any appropriate material, including, but not limited to, flexible materials, rigid materials, plastic, or metal. The liquid reservoir 10 is fluidally coupled to the pump 9 so that the pump 9 draws liquid from the liquid reservoir 10 to be dispensed through the spray nozzle 32. In the case that the liquid reservoir 10 is a removable cartridge, the liquid reservoir 10 may be attached to the pump 9 by any number of methods, including, but not limited to, a snap on connection or a threaded screw connection, and can be designed such that it is opened upon attachment to the pump 9 or manually opened before attachment to the pump 9. The liquid reservoir 10 is positioned adjacent to the partition 7 opposite the fan 6.

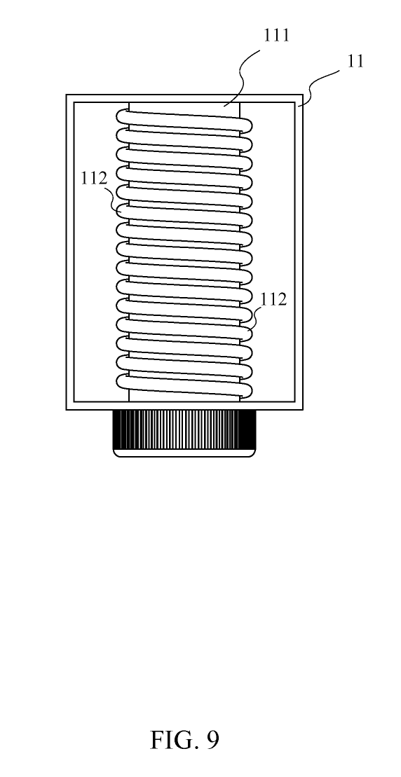

The heater 11 regulates the temperature of any fluid being dispensed through the spray nozzle 32. In one embodiment of the present invention, the heater 11 heats dispensed fluid to a preset temperature. In another embodiment of the present invention, the heater 11 heats dispensed fluid to a temperature determined by the user. The heater 11 is positioned within the cylindrical body 1 and coupled to the exit port 51 opposite the control valve. The heater 11 is also coupled in between the exit port 51 and the telescoping hose 3, so that the heater 11 adds thermal energy to any fluid passing through the exit port 51 to the spray nozzle 32. Referring to FIGS. 6 and 9, in one embodiment of the present invention, the heater 11 comprises a heating passage 111 of tubing connected in between the exit port 51 and the telescoping hose 3 with a plurality of heating coils 112 wrapped around the heating passage to which an electrical current is applied in order to heat the heating coils. In another embodiment of the present invention, the heater 11 is a heat lamp or any other well known or new technology that facilitates heating of any dispensed fluid.

The vibrator 12 is a mechanical device used to generate vibrations that is positioned within the cylindrical body 1 and connected to the cylindrical body 1 or to any other structure that facilitates vibrations being delivered through the cap 2 or the cylindrical body 1. In the preferred embodiment of the present invention, the vibrator 12 utilizes an electric motor 8 with a rotating unbalanced mass on the driveshaft of the motor 8 to generate vibrations. In one an alternate embodiment of the present invention, the vibrator 12 is positioned within and delivers vibrations through the spray nozzle 32. Any other well-known or new technology to facilitate vibration generation appropriate to the spirit of the present invention may be comprised in alternate embodiments of the present invention.

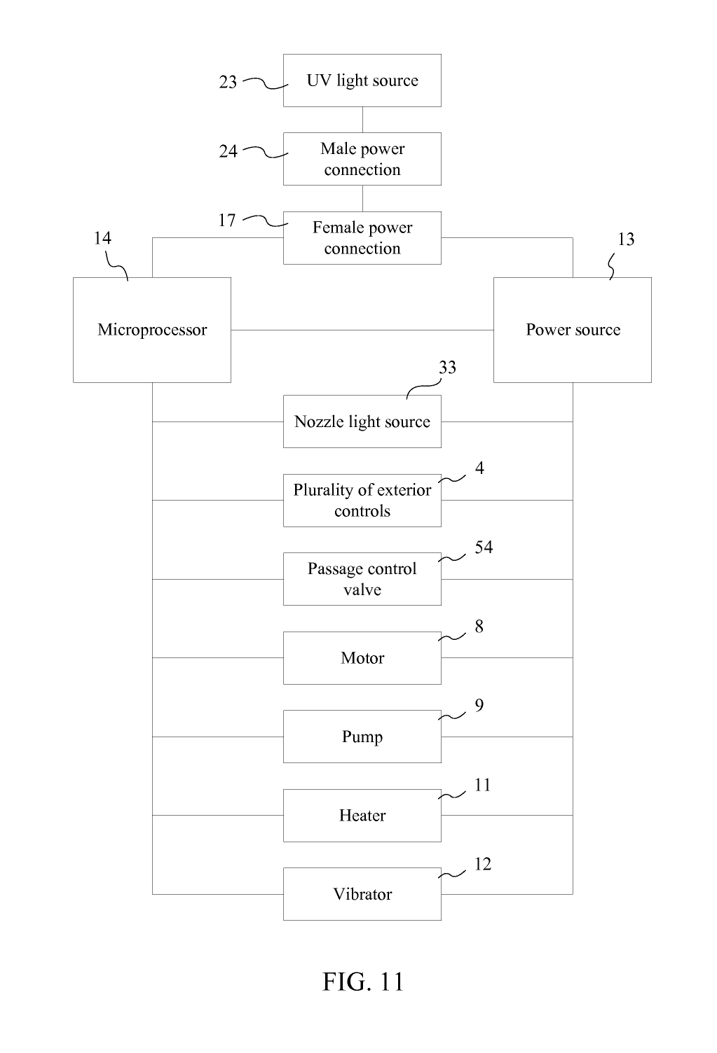

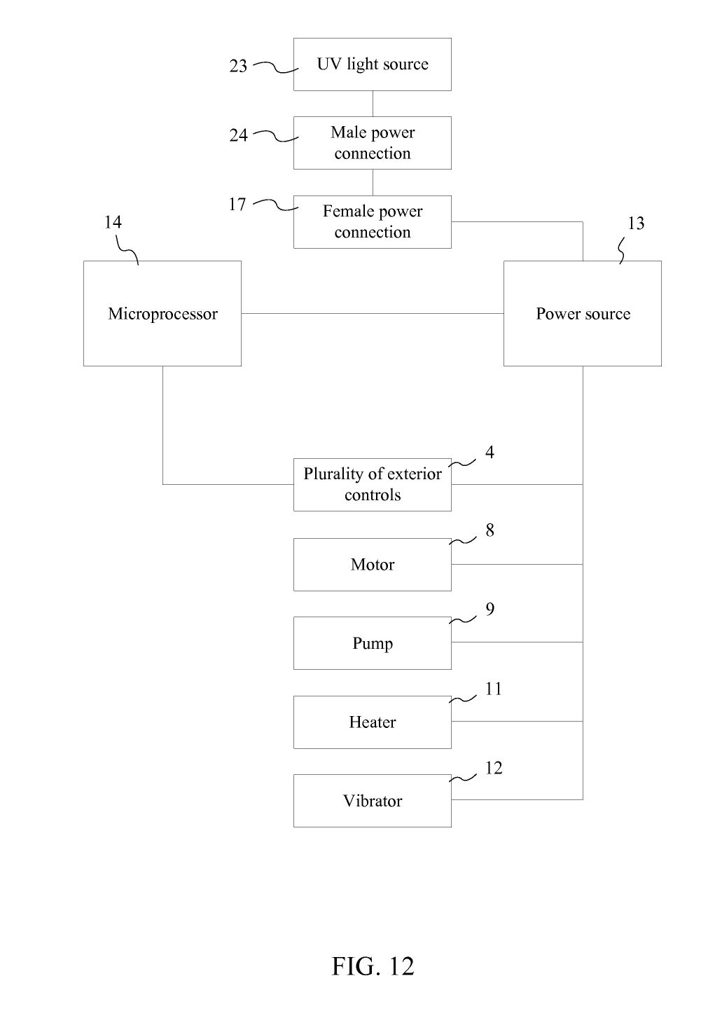

Referring to FIGS. 6, 7, the power source 13 is positioned within the cylindrical body 1 and provides electrical current to components of the present invention that require electricity to operate. The power source 13 may be any source of electricity appropriate to the spirit of the present invention, including, but not limited to, a rechargeable battery pack that is permanently fixed within the cylindrical body 1 and recharged by a connection to an outside electricity source, a removable rechargeable battery pack, or common disposable batteries. An alternate embodiment of the present invention may additionally or alternatively comprise a permanent wired connection for plugging into a wall socket or other outside electricity source. Referring to FIGS. 11-12, the power source 13 is electrically connected to the female power connection 17, the nozzle light source 33, the plurality of exterior controls 4, the motor 8, the pump 9, the heater 11, the vibrator 12, and the microprocessor 14. In one embodiment of the present invention, the power source 13 is also electrically connected to the passage control valve 54. In another embodiment of the present invention, the power source 13 is not connected to the nozzle light source 33. In another embodiment of the present invention, each or some of the plurality of exterior controls 4 are not connected to the power source 13. In other embodiments of the present invention, the power source is electrically connected to any components that require a source of power as necessary to implement the present invention.

Referring to FIGS. 11-12, the microprocessor 14 is an integrated circuit positioned within the cylindrical body 1 that incorporates the functions of a computer's central processing unit. The microprocessor 14 is a programmable device that accepts input digital signals, processes the input digital signals according to instructions stored on the microprocessor 14's memory, and produces output digital signals according to the instructions. The microprocessor 14 controls all the electronic functions of the present invention. The microprocessor 14 is electronically connected to the female power connection 17, the plurality of exterior controls 4, the passage control valve 54, the motor 8, the pump 9, the heater 11, and the vibrator 12. In one embodiment of the present invention, the microprocessor 14 is also connected to the nozzle light source 33. In another embodiment of the present invention, the microprocessor 14 is not connected to the passage control valve 54. In other embodiments of the present invention, the microprocessor is electronically connected to any components that require input digital signals and/or produce output digital signals as necessary to implement the present invention.

It is also possible for a carrying case to be included with the portable vibrating device. The carrying case could be either a soft or hard case. It is also a possibility for the carrying case to include sections to hold extra cartridges, batteries, hygiene products, pleasure products, etc. The carrying case acts to both protect the device and conceal it.

Although the present invention has been explained in relation to its preferred embodiment, it is to be understood that many other possible modifications and variations can be made without departing from the spirit and scope of the present invention as hereinafter claimed.

What is claimed is:

1. A portable vibrating bidet comprises,
a cylindrical body;
a cap;
a telescoping hose;
a plurality of exterior controls;
a junction tubing;
a fan;
a partition;
a motor;
a liquid reservoir;
a pump;
a heater;
a vibrator;
a power source;
a microprocessor;
a gripping pad;
the cylindrical body comprises a hose cavity, a female power connection, and a plurality of air vents;
the cap comprises an ultraviolet (UV) light source and a male power connection;
the telescoping hose comprises a plurality of flexible sections, a spray nozzle, and a nozzle light source; and
the junction tubing comprises an exit port, an air passage, a liquid passage, and a passage control valve.

2. The portable vibrating bidet as claimed in claim 1 comprises,
the plurality of air vents and the hose cavity being positioned opposite each other along the cylindrical body;
the plurality of exterior controls being positioned on the cylindrical body between the hose cavity and the plurality of air vents;
the gripping pad being positioned around the cylindrical body between the hose cavity and the plurality of air vents;
the hose cavity being concentrically positioned within the cylindrical body; and
the female power connection being positioned adjacent to the hose cavity.

3. The portable vibrating bidet as claimed in claim 1 comprises,
the cap being concentrically positioned with and removably engaged to the cylindrical body adjacent to the hose cavity;
the UV light source being concentrically positioned within the cap opposite the male power connection;
the UV light source being electrically connected to the male power connection; and
the male power connection being removably connected to the female power connection, wherein the female power connection allows electrical current to flow to the male power connection when the male power connection and the female power connection are connected to each other.

4. The portable vibrating bidet as claimed in claim 1 comprises,
the plurality of flexible sections being concentrically attached to and positioned within each other;
the plurality of flexible sections being telescopically engaged with each other, wherein the telescoping hose may be extended from and retracted into the hose cavity;
the plurality of flexible sections comprises a first section and a last section;
the first section and the last section being positioned opposite each other, wherein the first section and the last section are opposite extremities of the telescoping hose;
the first section being positioned within the hose cavity;
the spray nozzle being rotatably attached to the last section, wherein the spray nozzle can be rotated in order to control direction and flow characteristics of any fluid dispensed through the spray nozzle; and
the nozzle light source being positioned on the spray nozzle and oriented parallel to the spray nozzle.

5. The portable vibrating bidet as claimed in claim 1 comprises,
the heater, the vibrator, the pump, the power source, the microprocessor, the fan, partition, the motor, the liquid reservoir, and the junction tubing being positioned within the cylindrical body;
the liquid reservoir being fluidally coupled to the pump;
the liquid passage being fluidally coupled to the pump opposite the liquid reservoir, wherein the pump draws liquid from the liquid reservoir to the exit port through the liquid passage;
the exit port being fluidally coupled to the telescoping hose;
the heater being coupled in between the exit port and the telescoping hose;
the fan being positioned adjacent to the plurality of air vents;
the partition being positioned concentrically within the cylindrical body;
the partition being positioned adjacent to the fan opposite the plurality of air vents, wherein the partition is perimetrically sealed to the cylindrical body;
the liquid reservoir and the motor being positioned adjacent to the partition opposite the fan; and
the motor being operatively coupled with the fan through the partition.

6. The portable vibrating bidet as claimed in claim 1 comprises,
the exit port being fluidally coupled to the air passage through the passage control valve;
the exit port being fluidally coupled to the liquid passage through the passage control valve;
the liquid passage and the air passage being separated from each other by the passage control valve, wherein the exit port, the air passage, and the liquid passage intersect each other;
the passage control valve being positioned between the air passage, the liquid passage, and the exit port, wherein the passage control valve permits fluid flow to the exit port through either the air passage or the liquid passage;
the heater being coupled to the exit port opposite the passage control valve; and
the air passage traversing through the partition opposite the exit port.

7. The portable vibrating bidet as claimed in claim 1 comprises,
the power source being electrically connected to the female power connection, the nozzle light source, the plurality of exterior controls, the passage control valve, the motor, the pump, the heater, the vibrator, and the microprocessor; and
the microprocessor being electronically connected to the female power connection, the nozzle light source, the plurality of exterior controls, the passage control valve, the motor, the pump, the heater, and the vibrator.

8. A portable vibrating bidet comprises,
a cylindrical body;
a cap;
a telescoping hose;
a plurality of exterior controls;
a junction tubing;
a fan;
a partition;
a motor;
a liquid reservoir;
a pump;
a heater;
a vibrator;
a power source;
a microprocessor;
a gripping pad;
the cylindrical body comprises a hose cavity, a female power connection and a plurality of air vents;
the cap comprises an ultraviolet (UV) light source and a male power connection;
the telescoping hose comprises a plurality of flexible sections, a spray nozzle, and a nozzle light source;
the junction tubing comprises an exit port, an air passage, a liquid passage, and a passage control valve;
the plurality of flexible sections being concentrically attached to and positioned within each other;
the plurality of flexible sections being telescopically engaged with each other, wherein the telescoping hose may be extended from and retracted into the hose cavity;
the plurality of flexible sections comprises a first section and a last section;
the first section and the last section being positioned opposite each other, wherein the first section and the last section are opposite extremities of the telescoping hose;
the first section being positioned within the hose cavity;
the spray nozzle being rotatably attached to the last section, wherein the spray nozzle can be rotated in order to control direction and flow characteristics of any fluid dispensed through the spray nozzle;
the nozzle light source being positioned on the spray nozzle and oriented parallel to the spray nozzle;

9. The portable vibrating bidet as claimed in claim 8 comprises,
the plurality of air vents and the hose cavity being positioned opposite each other along the cylindrical body;
the plurality of exterior controls being positioned on the cylindrical body between the hose cavity and the plurality of air vents;
the gripping pad being positioned around the cylindrical body between the hose cavity and the plurality of air vents;
the hose cavity being concentrically positioned within the cylindrical body; and
the female power connection being positioned adjacent to the hose cavity.

10. The portable vibrating bidet as claimed in claim 8 comprises,
the cap being concentrically positioned with and removably engaged to the cylindrical body adjacent to the hose cavity;
the UV light source being concentrically positioned within the cap opposite the male power connection; and
the UV light source being electrically connected to the male power connection.
the male power connection being removably connected to the female power connection, wherein the female power connection allows electrical current to flow to the male power connection when the male power connection and the female power connection are connected to each other;

11. The portable vibrating bidet as claimed in claim 8 comprises,
the heater, the vibrator, the pump, the power source, the microprocessor, the fan, partition, the motor, the liquid reservoir, and the junction tubing being positioned within the cylindrical body;
the liquid reservoir being fluidally coupled to the pump;
the liquid passage being fluidally coupled to the pump opposite the liquid reservoir, wherein the pump draws liquid from the liquid reservoir to the exit port through the liquid passage;
the exit port being fluidally coupled to the telescoping hose;
the heater being coupled in between the exit port and the telescoping hose;
the fan being positioned adjacent to the plurality of air vents;
the partition being positioned concentrically within the cylindrical body;
the partition being positioned adjacent to the fan opposite the plurality of air vents, wherein the partition is perimetrically sealed to the cylindrical body;
the liquid reservoir and the motor being positioned adjacent to the partition opposite the fan; and
the motor being operatively coupled with the fan through the partition.

12. The portable vibrating bidet as claimed in claim 8 comprises,
the exit port being fluidally coupled to the air passage through the passage control valve;
the exit port being fluidally coupled to the liquid passage through the passage control valve;
the liquid passage and the air passage being separated from each other by the passage control valve, wherein the exit port, the air passage, and the liquid passage intersect each other;
the passage control valve being positioned between the air passage, the liquid passage, and the exit port, wherein the passage control valve permits fluid flow to the exit port through either the air passage or the liquid passage;
the heater being coupled to the exit port opposite the passage control valve; and
the air passage traversing through the partition opposite the exit port.

13. The portable vibrating bidet as claimed in claim 8 comprises,
the power source being electrically connected to the female power connection, the nozzle light source, the plurality of exterior controls, the passage control valve, the motor, the pump, the heater, the vibrator, and the microprocessor; and
the microprocessor being electronically connected to the female power connection, the nozzle light source, the plurality of exterior controls, the passage control valve, the motor, the pump, the heater, and the vibrator.

14. A portable vibrating bidet comprises,
a cylindrical body;
a cap;
a telescoping hose;
a plurality of exterior controls;
a junction tubing;
a fan;
a partition;
a motor;
a liquid reservoir;
a pump;
a heater;
a vibrator;
a power source;
a microprocessor;
a gripping pad;
the cylindrical body comprises a hose cavity, a female power connection and a plurality of air vents;
the cap comprises an ultraviolet (UV) light source and a male power connection;
the telescoping hose comprises a plurality of flexible sections, a spray nozzle, and a nozzle light source;
the junction tubing comprises an exit port, an air passage, a liquid passage, and a passage control valve;
the plurality of air vents and the hose cavity being positioned opposite each other along the cylindrical body;
the plurality of exterior controls being positioned on the cylindrical body between the hose cavity and the plurality of air vents;
the gripping pad being positioned around the cylindrical body between the hose cavity and the plurality of air vents;
the hose cavity being concentrically positioned within the cylindrical body;
the female power connection being positioned adjacent to the hose cavity;
the plurality of flexible sections being concentrically attached to and positioned within each other;
the plurality of flexible sections being telescopically engaged with each other, wherein the telescoping hose may be extended from and retracted into the hose cavity;
the plurality of flexible sections comprises a first section and a last section;
the first section and the last section being positioned opposite each other, wherein the first section and the last section are opposite extremities of the telescoping hose;
the first section being positioned within the hose cavity;
the spray nozzle being rotatably attached to the last section, wherein the spray nozzle can be rotated in order to control direction and flow characteristics of any fluid dispensed through the spray nozzle; and
the nozzle light source being positioned on the spray nozzle and oriented parallel to the spray nozzle.

15. The portable vibrating bidet as claimed in claim 14 comprises,
the cap being concentrically positioned with and removably engaged to the cylindrical body adjacent to the hose cavity;
the UV light source being concentrically positioned within the cap opposite the male power connection;
the UV light source being electrically connected to the male power connection;
the male power connection being removably connected to the female power connection, wherein the female power connection allows electrical current to flow to the male power connection when the male power connection and the female power connection are connected to each other;

16. The portable vibrating bidet as claimed in claim 14 comprises,
the heater, the vibrator, the pump, the power source, the microprocessor, the fan, partition, the motor, the liquid reservoir, and the junction tubing being positioned within the cylindrical body;
the liquid reservoir being fluidally coupled to the pump;
the liquid passage being fluidally coupled to the pump opposite the liquid reservoir, wherein the pump draws liquid from the liquid reservoir to the exit port through the liquid passage;
the exit port being fluidally coupled to the telescoping hose;
the heater being coupled in between the exit port and the telescoping hose;
the fan being positioned adjacent to the plurality of air vents;
the partition being positioned concentrically within the cylindrical body;
the partition being positioned adjacent to the fan opposite the plurality of air vents, wherein the partition is perimetrically sealed to the cylindrical body;
the liquid reservoir and the motor being positioned adjacent to the partition opposite the fan; and
the motor being operatively coupled with the fan through the partition.

17. The portable vibrating bidet as claimed in claim 14 comprises,
the exit port being fluidally coupled to the air passage through the passage control valve;
the exit port being fluidally coupled to the liquid passage through the passage control valve;
the liquid passage and the air passage being separated from each other by the passage control valve, wherein the exit port, the air passage, and the liquid passage intersect each other;
the passage control valve being positioned between the air passage, the liquid passage, and the exit port, wherein the passage control valve permits fluid flow to the exit port through either the air passage or the liquid passage;
the heater being coupled to the exit port opposite the passage control valve; and
the air passage traversing through the partition opposite the exit port.

18. The portable vibrating bidet as claimed in claim 14 comprises,
the power source being electrically connected to the female power connection, the nozzle light source, the plurality of exterior controls, the passage control valve, the motor, the pump, the heater, the vibrator, and the microprocessor; and
the microprocessor being electronically connected to the female power connection, the nozzle light source, the plurality of exterior controls, the passage control valve, the motor, the pump, the heater, and the vibrator.
